(19) United States
(12) Patent Application Publication
(10) Pub. No.: US 2018/0309306 A1
(43) Pub. Date: Oct. 25, 2018

(54) HAND-HELD POWER TOOL CHARGING DEVICE

(71) Applicant: Robert Bosch GmbH, Stuttgart (DE)

(72) Inventors: Martin Gonda, Buehl (DE); Dragan Krupezevic, Stuttgart (DE); Juergen Mack, Goeppingen (DE)

(21) Appl. No.: 15/759,028

(22) PCT Filed: Jul. 22, 2016
(86) PCT No.: PCT/EP2016/067550

§ 371 Date: Mar. 9, 2018

(30) Foreign Application Priority Data
Aug. 21, 2015 (DE) 10 2015 216 038.6

(51) Int. Cl. H02J 7/00; H02J 7/02

(52) U.S. Cl. CPC H02J 7/0027; H02J 50/12; H02J 7/0004; H02J 7/025

(57) ABSTRACT

A handheld power tool charging device for energy stores of handheld power tools, provided for a wireless energy transmission, having a first charging region and a first detection unit for a detection of a foreign body in the first charging region, and having at least one additional charging region, and at least one additional detection unit for a detection of a foreign body in the at least one additional charging region. The detection units are at least partly coordinated with one another.

### FIELD

A handheld power tool charging device for energy stores of handheld power tools provided for wireless transmission of energy, having a first charging region and a first detection unit for detecting a foreign body in the first charging region, and having at least one additional charging region and at least one additional detection unit for detecting a foreign body in the at least one additional charging region, has been proposed.

### SUMMARY

The present invention relates to a handheld power tool charging device for energy stores of handheld power tools, provided for a wireless transmission of energy, having a first charging region and a first detection unit for detecting a foreign body in the first charging region, and having at least one additional charging region and at least one additional detection unit for detecting a foreign body in the at least one additional charging region.

In accordance with the present invention, the detection units are at least partly coordinated with one another. In this way, mutual interference of the detection units during a process of detecting foreign bodies, as the first phase of a charging process, can be avoided particularly effectively. An unfalsified and/or reliable detection result can be achieved in preparation for a charging process. A particularly reliable handheld power tool charging device can be provided. A particularly efficient charging process can be achieved. In the present context, a “handheld power tool charging device” is to be understood in particular as a charging device for charging at least one energy store for handheld power tools, preferably a plurality of energy stores for handheld power tools. In the present context, a “handheld power tool” is to be understood in particular as a tool that processes workpieces, but advantageously a drill, a hammer drill and/or percussion hammer, a saw, a planer, a screwdriver, a milling machine, a grinder, an angle grinder, a garden tool, and/or a multifunction tool. Preferably, the energy stores to be charged include at least one rechargeable battery pack. Preferably, the energy stores have a nominal voltage of less than 50 V, preferably less than 40 V, particularly preferably less than 20 V. Preferably, the energy stores to be charged have a storage capacity of less than 10.0 Ah, preferably less than 5.0 Ah, particularly preferably less than 4.0 Ah. Preferably, the handheld power tool charging device is fashioned as an inductive charging device. Preferably, the energy stores to be charged are provided for inductive charging, and each have at least one secondary coil. In the present context, a “charging region” is to be understood in particular as a region that is provided to accept at least one energy store at least for a charging process. Preferably, the handheld power tool machine charging device has at least one housing surface that limits the charging region and/or on which an energy store to be charged is situated at least for a charging process. In the present context, a “foreign body” is to be understood as an object, in particular an at least partly metallic object, that due to its extension, its mechanical properties, and/or its electromagnetic properties would impair and/or make impossible a charging process when situated in a charging region. In the present context, a detection of a foreign body is to be understood as a process in which a detection unit checks whether a foreign body is situated in a charging region, in particular whether a foreign body is situated on a housing surface of the handheld power tool charging device that limits the charging region. Preferably, the detection units each have an output unit respectively provided to output a result of the detection process so as to be recognizable to a user. Preferably, the output unit is provided for the outputting of an optical, an acoustic, and/or a haptic signal. It is possible for each of the output units to be made at least partly in one piece with output units that are provided for the display of a status value of a charging process. It is possible that the handheld power tool charging device has a central output unit that is provided to output a signal recognizable by a user as a function of at least one result of the detection process. Preferably, the detection unit and the at least one additional detection unit are made identical to one another in their construction. A particularly large number of common parts can be achieved. A particularly low-cost power tool charging device can be provided. It is possible that the detection unit and the at least one additional detection unit are realized differently from one another. “Provided” is to be understood in particular as meaning specifically programmed, designed, and/or equipped. The statement that an object is provided for a particular function is to be understood in particular as meaning that the object fulfills and/or performs this particular function in at least one state of use and/or state of operation.

In an advantageous embodiment, the handheld power tool charging device includes a first transmit unit that is provided to radiate energy for the energy transmission, and that is made at least partly in one piece with the first detection unit, as well as at least one additional transmit unit that is provided to radiate energy for the energy transmission and that is made at least partly in one piece with the at least one additional detection unit. In this way, a particularly compact handheld power tool charge device can be provided. A particularly convenient charging process can be achieved. Preferably, the first transmit unit and the at least one additional transmit unit are each provided to produce a magnetic alternating field for the energy transmission. In the present context, the statement that a detection unit and a transmit unit are made “at least partly in one piece with one another” is to be understood as meaning in particular that the detection unit and the transmit unit have at least one common coil, in particular a common primary coil, that is provided to produce a magnetic alternating field, in particular for the energy transmission.

Advantageously, the detection units are at least partly temporally coordinated with one another. In this way, a mutual interference of the detection units during a detection process can be particularly easily avoided through the design. A handheld power tool charging device particularly flexible in its use can be provided. In the present context, the statement that the detection units are “temporally coordinated” is to be understood in particular as meaning that the detection units are provided to temporally coordinate a detection process for detecting the foreign body with one another, in particular to temporally coordinate a start time and/or an end time with one another, and/or to carry out a detection process for the detection of the foreign body at least in temporally offset fashion and/or in succession. It is possible that the detection units are each provided to determine when there is interference with the detection process by one of the other detection units. It is possible that the detection units are provided to determine and/or to shift a start time and/or an end time of the detection process as a function of a determined interference with the detection process by one of the other detection units.

In addition, it is provided that the first detection unit and/or the at least one additional detection unit are provided to begin the detection of a foreign body in the first charging region and/or the detection of a foreign body in the at least one additional charging region at at least essentially random times. In this way, a probability of mutual interference during a detection process can be particularly easily limited, for example through a software expansion, or a mutual interference in detection processes by different detection units can particularly easily be avoided. A particularly low-cost handheld power tool charging device can be provided. In the present context, “at least essentially random times” is to be understood in particular as meaning times that are determined by at least one random number or pseudorandom number. Preferably, each of the detection units has at least one random number generator provided to provide a random number or a pseudorandom number for determining random times. It is possible that the random number generator is realized as a software function. Alternatively, the handheld power tool charging device can have a central random number generator provided to provide a random number or a pseudorandom number for determining random times. It is possible that the detection units are not coordinated with one another and are provided only for the detection of a foreign body in the first charging region and/or the detection of a foreign body in the at least one additional charging region at at least essentially random times. In an alternative embodiment, the handheld power tool charging device can have a first operating mode in which the detection units are at least partly coordinated with one another and at least one additional operating mode in which the first detection unit and/or the at least one additional detection unit are provided to begin the detection of a foreign body in the first charging region and/or the detection of a foreign body in the at least one additional charging region at at least essentially random times. It is possible that the at least one additional operating mode is provided as a fallback mode, for example for a state in which a coordination of the detection units is interfered with.

In an advantageous embodiment, the first detection unit has at least one frequency channel having a frequency and the at least one additional detection unit has at least one additional frequency channel having a frequency differing from the frequency channel of the first detection unit. In this way, a multiplicity of detection processes can be carried out in parallel without interference. Foreign bodies can be detected particularly efficiently. Preferably, the frequency channel determines a frequency for a detection and/or for a transmission of energy.

In addition, it is provided that the first detection unit and/or the at least one additional detection unit has a plurality of selectable frequency channels. In this way, a mutual interference with a detection process can be avoided in a particularly flexible manner. Advantageously, a handheld power tool charging device can be provided that can be expanded by one or more charging regions. It is possible that the handheld power tool charging device has at least one operating unit that enables a user to select a respective frequency channel. It is in addition possible that the detection units are provided to determine a mutual interference with the detection process. It is possible that the detection units are provided to determine a frequency channel as a function of a determined interference with the detection process by one of the other detection units.

In an advantageous embodiment, the first detection unit and the at least one additional detection unit each have an interface for a data transmission. In this way, a particularly reliable data transmission can be achieved for a coordination of the detection units. Preferably, the interface of the first detection unit and the interfaces of the additional detection units are provided for data transmission of the detection units among one another. Alternatively, it is possible that the handheld power tool charging device has a central control and/or regulating unit and the interfaces are provided to each be connected to the central control and/or regulating unit in terms of signals and/or data.

In an advantageous embodiment, the first detection unit and the at least one additional detection unit each have at least one bus interface for a data transmission. In this way, a reliability of the data transmission can be additionally increased. Preferably, the bus interface of the first detection unit and the bus interfaces of the additional detection units are provided for a data transmission of the detection units among one another.

In addition, it is provided that the first detection unit and the at least one additional detection unit each have at least one interface for a wireless data transmission. In this way, a particularly simple assembly of the handheld power tool charging device can be achieved. In the present context, a “wireless data transmission” is to be understood in particular as a data transmission using electromagnetic waves, for example light waves, radio waves, or infrared waves, or a data transmission using sound waves. Preferably, the interfaces are realized according to a standard considered suitable by a person skilled in the art, for example as Wi-Fi interfaces or as Bluetooth interfaces.

In addition, a system is provided having a handheld power tool charging device according to the present invention and having at least one energy store that is provided to be charged by the handheld power tool charging device and in at least one operating state to supply energy to a handheld power tool. In this way, a particularly reliable system can be provided for charging energy stores for handheld power tools. In particular, the energy store is provided to supply energy to a drive unit of the handheld power tool. Preferably, the system has at least one additional energy store provided to be charged by the handheld power tool charging device and in at least one operating state to supply energy to a handheld power tool.

In addition, a method is proposed for the wireless charging of energy stores for handheld power tools by a handheld power tool charging device, in which a first detection unit of the handheld power tool charging device carries out a detection of a foreign body in a first charging region of the handheld power tool charging device, and at least one additional detection unit carries out a detection of a foreign body in at least one additional charging region of the handheld power tool charging device. In this way, a particularly user-friendly method can be achieved for charging energy stores for handheld power tools. A plurality of energy stores can be charged particularly reliably. A particularly efficient method can be achieved.

Advantageously, the at least one additional detection unit carries out the detection of a foreign body in the at least one additional charging region at least partly in temporal coordination with the detection of a foreign body by the first detection unit in the first charging region. In this way, a particularly simple method for avoiding interference during a detection process can be achieved.

In addition, it is provided that the first detection unit carries out the detection of a foreign body in the first charging region with a first frequency and the at least one additional detection unit carries out the detection of a foreign body in the additional charging region with a frequency differing from the first frequency. In this way, a particularly efficient method can be achieved in which a plurality of detection units detect a foreign body in a charging region simultaneously and/or at least in temporally overlapping fashion.

The handheld power tool charging device according to the present invention is not intended to be limited to the specific embodiments described herein. In particular, the handheld power tool charging device according to the present invention can have a number of individual elements, components, and units differing from a number described herein in order to perform a function described herein.

### BRIEF DESCRIPTION OF THE DRAWINGS

Additional advantages result from the description below of the figures. The figures shows three exemplary embodiments of the present invention. The figures and the description herein contain numerous features in combination. A person skilled in the art will usefully also regard the features individually and combine them to form appropriate further combinations.

FIG. 1 shows a system according to the present invention having a handheld power tool charging device and having energy stores, in a schematic view.

FIG. 2 shows a schematic representation of the handheld power tool charging device having a bus.

FIG. 3 shows a schematic representation of another exemplary embodiment of the handheld power tool charging device, having interfaces for a wireless data transmission.

FIG. 4 shows a schematic representation of another exemplary embodiment, having random beginning times for the detection of a foreign body in corresponding charging regions.

### DETAILED DESCRIPTION OF EXAMPLE EMBODIMENTS

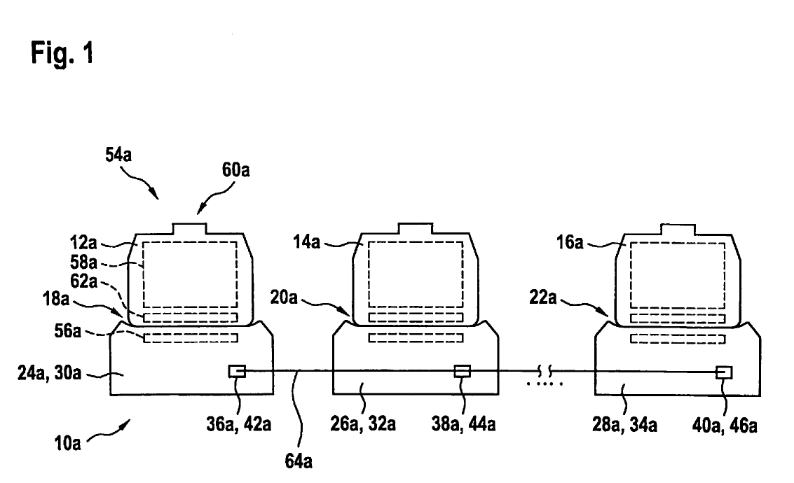

FIG. 1 shows a system 54a having a handheld power tool charging device 10a and having a plurality of energy stores 12a, 14a, 16a for handheld power tools (not shown in more detail). Energy stores 12a, 14a, 16a are each provided to be charged by handheld power tool charging device 10a, and to each supply energy, in at least one operating state, to a handheld power tool. Energy stores 12a, 14a, 16a are each provided to supply energy to at least one drive unit of a respective handheld power tool. Handheld power tool charging device 10a is provided for charging energy stores 12a, 14a, 16a. Handheld power tool charging device 10a is provided for a wireless transmission of energy. Handheld power tool charging device 10a has a first charging region 18a and a first detection unit 24a for a detection of a foreign body in first charging region 18a.

Handheld power tool charging device 10a has at least one additional charging region 20a, 22a and at least one additional detection unit 26a, 28a for a detection of a foreign body in additional charging region 20a, 22a. In the present exemplary embodiment, handheld power tool charging device 10a has a plurality of additional charging regions 20a, 22a. In the present exemplary embodiment, handheld power tool charging device 10a has more than three charging regions 18a, 20a, 22a. Handheld power tool charging device 10a has a plurality of additional detection units 26a, 28a. A number of detection units 24a, 26a, 28a corresponds to a number of charging regions 18a, 20a, 22a. A respective charging region 18a, 20a, 22a is assigned to a respective detection unit 24a, 26a, 28a. Detection units 24a, 26a, 28a are respectively provided for a detection of a foreign body in charging region 18a, 20a, 22a assigned to the respective detection unit 24a, 26a, 28a. Detection units 24a, 26a, 28a of handheld power tool charging device 10a are at least partly coordinated with one another.

Handheld power tool charging device 10a is formed as an inductive charging device. Handheld power tool charging device 10a has a first transmit unit 30a that is provided to radiate energy for the energy transmission, and is made at least partly in one piece with first detection unit 24a. Handheld power tool charging device 10a has at least one additional transmit unit 32a, 34a that is provided to radiate energy for the energy transmission, and is at least partly made in one piece with the at least one additional detection unit 26a, 28a. In the present exemplary embodiment, handheld power tool charging device 10a has a plurality of transmit units 30a, 32a, 34a, each provided to radiate energy for the energy transmission and each made at least partly in one piece with a respective one of the detection units 24a, 26a, 28a. Transmit units 30a, 32a, 34a are made analogously to one another, for which reason in the following only first transmit unit 30a is described in more detail. First transmit unit 30a has a coil 56a. Coil 56a of transmit unit 30a is fashioned as a primary coil. Coil 56a of transmit unit 30a is provided to convert electrical energy into magnetic field energy for the energy transmission. Coil 56a is provided to produce a magnetic alternating field.

First charging region 18a of handheld power tool charging device 10a is provided to accept a first of the energy stores 12a, at least for a charging process. The additional charging regions 20a, 22a of handheld power tool charging device 10a are provided to accept the additional energy stores 14a, 16a at least for a charging process. First charging region 18a and additional charging regions 20a, 22a each have a maximum extension, which in the present exemplary embodiment is less than 200 mm. During a charging process, each of the energy stores 12a, 14a, 16a is situated in a respective charging region 18a, 20a, 22a. Energy stores 12a, 14a, 16a, provided for charging in first charging region 18a and/or in the additional charging regions 20a, 22a, are fashioned analogously to one another, for which reason in the following only a first energy store 12a is described in more detail. Energy store 12a has a rechargeable battery pack 58a. In the present exemplary embodiment, energy store 12a has a nominal voltage of 18 V. Energy store 12a has an interface 60a for electrical and mechanical coupling to a handheld power tool. It is possible that during a charging process energy store 12a is situated in charging region 18a, in a state coupled with a power tool. It is possible that energy store 12a is integrated into the power tool. Energy store 12a has a coil 62a. Coil 62a of energy store 12a is fashioned as a secondary coil, and is provided to convert a magnetic field energy into an electrical current. Coil 62a of energy store 12a is provided to work together with coil 56a of transmit unit 30a for the energy transmission. Charging regions 18a, 20a, 22a are each provided to respectively situate coils 62a of energy stores 12a, 14a, 16a spatially, relative to coils 56a of transmit units 30a, 32a, 34a.

Detection units 24a, 26a, 28a are at least partly temporally coordinated with one another. Detection units 24a, 26a, 28a are provided to detect a foreign body in charging regions 18a, 20a, 22a, respectively assigned to them, in temporally offset fashion. Detection units 24a, 26a, 28a are provided to detect, in succession, a foreign body in charging regions 18a, 20a, 22a respectively assigned to them. Relating to a detection process, handheld power tool charging device 10a has a sequence of detection units 24a, 26a, 28a. It is possible for the sequence to be determinable by a user. It is possible that handheld power tool charging device 10a has an operating unit that is provided for a determination of the sequence by a user. Detection units 24a, 26a, 28a are provided to begin the detection process for detecting a foreign body after a conclusion of a detection process by a detection unit 24a, 26a, 28a that is immediately preceding in the sequence. The sequence of detection units 24a, 26a, 28a is determined dynamically in the present exemplary embodiment. Alternatively, it is possible that the sequence of the detection units 24a, 26a, 28a for the detection process is determined statically. For example, the detection units 24a, 26a, 28a are provided to detect a foreign body in the charging region 18a, 20a, 22a respectively assigned to them, in an operating state, in succession corresponding to a spatial configuration, in particular corresponding to a spatial linear configuration, of charging regions 18a, 20a, 22a. It is possible that detection units 24a, 26a, 28a detect a foreign body in the charging region 18a, 20a, 22a respectively assigned thereto in a different sequence that appears suitable to a person skilled in the art, for example as a function of a device type. It is possible that the detection units 24a, 26a, 28a are assigned to different groups, for example corresponding to a spatial configuration, in particular corresponding to a spatial linear configuration. It is possible that the groups are at least partly temporally coordinated with one another, and for example the detection units 24a, 26a, 28a of a group carry out the detection process in succession or simultaneously.

First detection unit 24a has at least one frequency channel having a frequency. Additional detection units 26a, 28a each have additional frequency channels each having frequencies differing from the frequency channel of first detection unit 24a. In the present exemplary embodiment, detection units 24a, 26a, 28a have frequency channels having pairwise different frequencies. Detection units 24a, 26a, 28a are fashioned analogously to one another, for which reason in the following only first detection unit 24a is described in more detail. Detection unit 24a is provided to produce and/or to evaluate an electromagnetic signal having the frequency of the frequency channel for the detection of a foreign body in charging region 18a assigned to detection unit 24a. Detection unit 24a has an oscillating circuit that is set to the frequency of the frequency channel and/or that is provided to be set to the frequency of the frequency channel. The frequency of the frequency channel is realized as a resonant frequency of the oscillating circuit. The oscillating circuit is provided to produce at least the electromagnetic signal for the detection of a foreign body.

It is possible that detection units 24a, 26a, 28a have a common frequency channel having a common frequency that is provided for a detection of a foreign body in charging region 18a, 20a, 22a assigned to the respective detection unit 24a, 26a, 28a. It is possible that detection units 24a, 26a, 28a are only temporally coordinated with one another. It is also possible that detection units 24a, 26a, 28a are not temporally coordinated with one another, and for a coordination have only frequency channels having different frequencies.

In the present exemplary embodiment, first detection unit 24a has a plurality of selectable frequency channels. Additional detection units 26a, 28a each have a plurality of selectable frequency channels. Detection units 24a, 26a, 28a each have at least one control and/or regulating unit. The control and/or regulating units are provided to automatically coordinate the frequency channels of detection units 24a, 26a, 28a among one another for a detection of a foreign body in charging region 18a, 20a, 22a assigned to the respective detection unit 24a, 26a, 28a. Alternatively, it is possible that the frequency channels of the detection units 24a, 26a, 28a are statically coordinated for a detection of a foreign body in charging region 18a, 20a, 22a assigned to the respective detection unit 24a, 26a, 28a. It is also possible that detection units 24a, 26a, 28a each have an operating element (not shown in more detail) that is provided for actuation by a user for a selection of a frequency channel as an active frequency channel. It is possible that handheld power tool charging device 10a has a central operating element that is provided for an actuation by user for a selection and/or assignment of frequency channels to detection units 24a, 26a, 28a. In the present exemplary embodiment, the oscillating circuits of detection units 24a, 26a, 28a have adjustable resonant frequencies. For example, characteristic quantities such as a capacitance and/or an inductance of at least one oscillating circuit element can be modified. In an alternative embodiment, the control and/or regulating units make it possible to excite the oscillating circuits with an adjustable frequency.

First detection unit 24a and additional detection units 26a, 28a each have at least one interface 36a, 38a, 40a for a data transmission. Interface 36a of first detection unit 24a and interfaces 38a, 40a of additional detection units 26a, 28a are provided for an exchange of data of detection units 24a, 26a, 28a among one another. Interfaces 36a, 38a, 40a are provided for a coordination of detection units 24a, 26a, 28a among one another. In the present exemplary embodiment, interfaces 36a, 38a, 40a are provided to communicate and/or to receive signals for a dynamic coordination of the sequence of the detection processes of detection units 24a, 26a, 28a. In the present exemplary embodiment, detection units 24a, 26a, 28a coordinate a sequence dynamically, for example on the basis of a prioritization among one another. The prioritization can be realized as a function of a device type of handheld power tool charging device 10a, as a device type of an energy store 12a, 14a, 16a that is to be charged, as a function of a spatial configuration of charging regions 18a, 20a, 22a, and/or as a function of some other parameter that appears suitable to a person skilled in the art.

In the present exemplary embodiment, interfaces 36a, 38a, 40a are provided to communicate signals for a dynamic coordination of the frequency channels of detection units 24a, 26a, 28a. It is possible that detection units 24a, 26a, 28a coordinate the frequency channels for a detection of a foreign body as a function of a device type of rechargeable battery pack 58 that is to be charged, as a function of a spatial configuration of charging regions 18a, 20a, 22a and/or as a function of some other parameter that appears suitable to a person skilled in the art. Interface 36a of first detection unit 24a and interfaces 38a, 40a of additional detection units 24a, 26a, 28a are each provided for a wire-bound data transmission.

First detection unit 24a and additional detection units 26a, 28a each have a bus interface 42a, 44a, 46a for a data transmission. Interface 36a of first detection unit 24a is realized as a bus interface 42a. Interfaces 38a, 40a of additional detection units 26a, 28a are each realized as a bus interface 44a, 46a. Handheld power tool charging device 10a has a bus 64a that, in an assembled state, connects detection units 24a, 26a, 28a to one another in terms of signals, via bus interfaces 42a, 44a, 46a of detection units 24a, 26a, 28a. Bus interface 42a of first detection unit 24a is provided for a connection, in terms of signals, of first detection unit 24a to bus 64a of handheld power tool charging device 10a. Bus interfaces 44a, 46a of the additional detection units 26a, 28a are each provided for a connection in terms of signals of additional detection units 26a, 28a to bus 64a of handheld power tool charging device 10a.

In a method for the wireless charging of energy stores 12a, 14a, 16a of handheld power tools using handheld power tool charging device 10a, first detection unit 24a of handheld power tool charging device 10a carries out a detection of a foreign body in first charging region 18a of handheld power tool charging device 10a, and additional detection units 26a, 28a of handheld power tool charging device 10a carry out a detection of a foreign body in additional charging regions 20a, 22a of handheld power tool charging device 10a in coordination with one another. In the method, first detection unit 24a produces an electromagnetic signal and/or evaluates it. In coordination with first detection unit 24a, and in coordination with one another, the additional detection units 26a, 28a produce an electromagnetic signal and/or evaluate it.

In the method, additional detection units 26a, 28a carry out the detection of a foreign body in additional charging regions 20a, 22a in at least partial temporal coordination with the detection of a foreign body by first detection unit 24a in first charging region 18a. In the present exemplary embodiment, first detection unit 24a and additional detection units 26a, 28a carry out the respective detection process in a manner dynamically coordinated with one another. For example, the control and/or regulating units of detection units 24a, 26a, 28a ascertain a priority value that is assigned respectively to one of the detection units 24a, 26a, 28a, and, on the basis of the priority value, coordinate a sequence with regard to the detection process. Detection units 24a, 26a, 28a coordinate the sequence with one another via a data transmission via interfaces 36a, 38a, 48a. Detection units 24a, 26a, 28a determine the priority value for example as a function of a device type, as a function of a device number, as a function of a spatial configuration of charging regions 18a, 20a, 22a assigned to detection units 24a, 26a, 28a, and/or as a function of some other parameter that appears appropriate to a person skilled in the art.

One of the detection units 24a has a first position in the sequence, for example first detection unit 24a. Detection unit 24a carries out the detection process for charging region 18a assigned to it. Detection unit 24a communicates the conclusion of the detection process to the subsequently (in the sequence) situated detection units 26a, 28a, via interface 36a of detection unit 24a. One of the detection units 26a has a second position in the sequence. Detection unit 26a carries out the detection process analogously to detection unit 24a at the first position. Detection unit 26a at the second position communicates the conclusion of the detection process to the subsequently (in the sequence) situated detection units 28a, via interface 38a of detection unit 26a. The subsequently (in the sequence) situated detection units 28a carry out the detection process analogously.

In an alternative embodiment, for the coordination of a sequence detection units 24a, 26a, 28a carry out the detection process, as a test, at least in part simultaneously. Here detection units 24a, 26a, 28a determine whether the detection process is interfered with by some other detection unit 24a, 26a, 28a. If there is interference, detection units 24a, 26a, 28a each postpone the start time for their detection process. As a function of a result of a test of whether a detection process is interfered with by another detection unit 24a, 26a, 28a, detection units 24a, 26a, 28a each carry out the detection process in temporally offset fashion and/or in succession.

In the method, first detection unit 24a carries out the detection of a foreign body in first charging region 18a with a first frequency, and additional detection units 26a, 28a carry out the detection of a foreign body in the additional charging regions 20a, 22a with a frequency differing from the first frequency. In the present exemplary embodiment, additional detection units 26a, 28a carry out the detection of a foreign body in additional charging regions 20a, 22a with a frequency different from the first frequency and with a pairwise different frequency. In the present exemplary embodiment, first detection unit 24a and additional detection units 26a, 28a carry out the respective detection process in a manner dynamically coordinated with one another, with regard to a frequency. Detection units 24a, 26a, 28a determine the frequencies of the individual detection units 24a, 26a, 28a for example as a function of a device type, as a function of a device number, as a function of a spatial configuration of charging regions 18a, 20a, 22a assigned to detection units 24a, 26a, 28a, and/or as a function of some other parameter that appears appropriate to a person skilled in the art. Detection units 24a, 26a, 28a communicate the frequencies of detection units 24a, 26a, 28a via interfaces 36a, 38a, 40a. It is possible that in the method detection units 24a, 26a, 28a coordinate the detection process only temporally. It is possible that in the method detection units 24a, 26a, 28a detect a foreign body in the charging region 18a, 20a, 22a, assigned to the respective detection unit 24a, 26a, 28a, with a common frequency. Alternatively, it is possible that in the method detection units 24a, 26a, 28a coordinate the detection process only with regard to the frequencies.

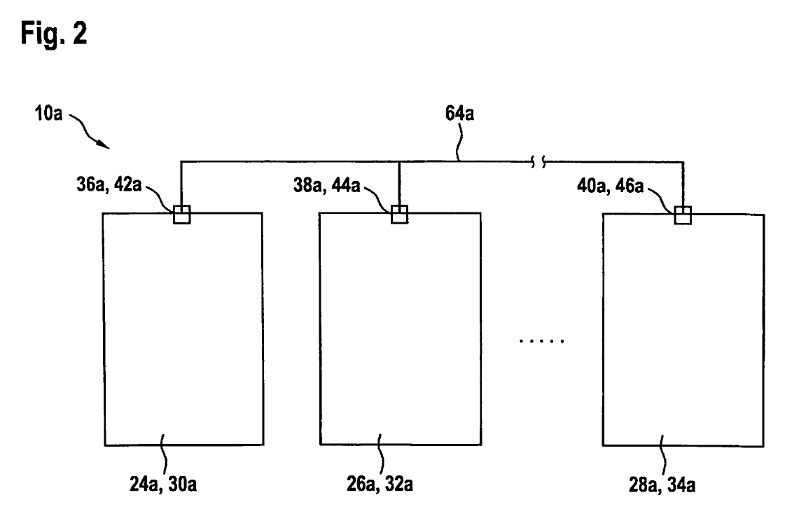

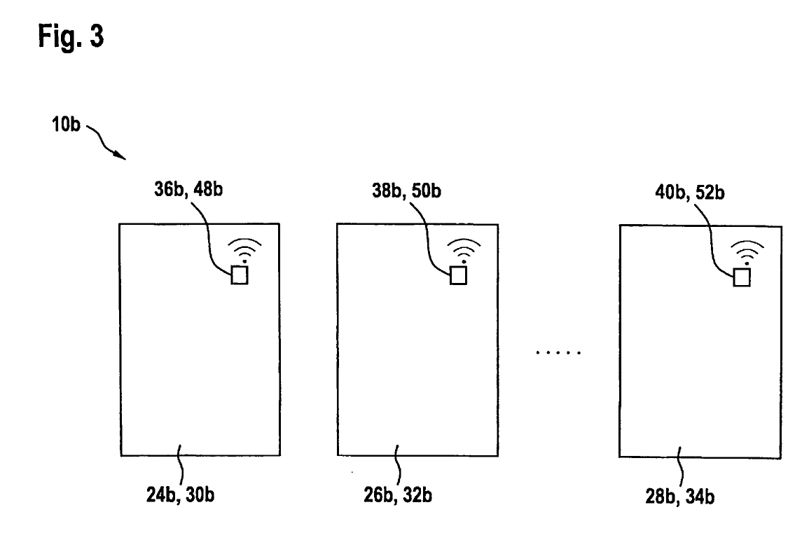

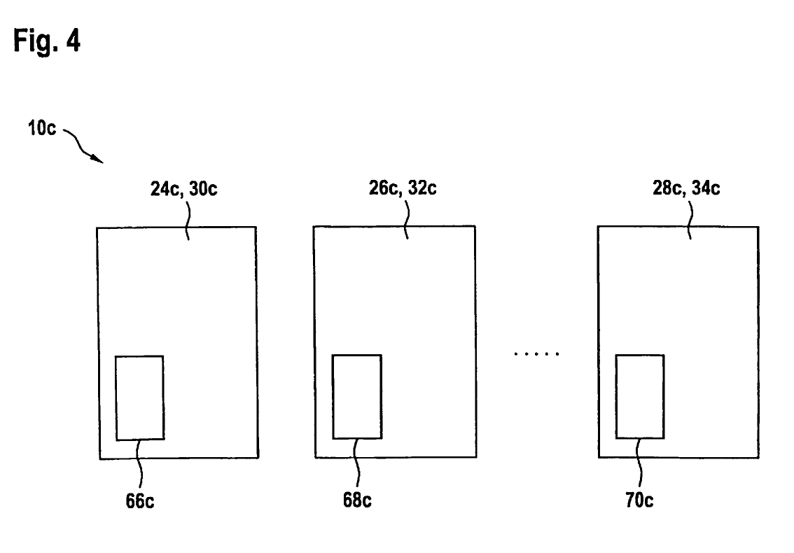

FIGS. 3 and 4 show another exemplary embodiment of the present invention. The description below is limited essentially to the differences between the exemplary embodiments, such that with regard to identically designated components, in particular components having identical reference characters, reference can also be made to the drawings and/or the description of the other exemplary embodiments, in particular of FIGS. 1 and 2. In order to distinguish the exemplary embodiments, the letter “a” has been appended to the reference characters of the exemplary embodiment in FIGS. 1 and 2. In the exemplary embodiments of FIGS. 3 through 5, the letter “a” is replaced by the letters “b” and “c.”

FIG. 3 shows another exemplary embodiment of a handheld power tool charging device 10b for energy stores of handheld power tools, provided for wireless energy transmission. Handheld power tool charging device 10b has, analogously to the preceding exemplary embodiment, a first charging region and a first detection unit 24b for detecting a foreign body in the first charging region. Handheld machine charging tool 10b has at least one additional charging region and at least one additional detection unit 26b, 28b for detecting a foreign body in the additional charging regions. Handheld power tool charging device 10b has a plurality of additional charging regions. A number of detection units 24b, 26b, 28b corresponds to a number of charging regions. Each charging region is assigned to a respective detection unit 24b, 26b, 28b. Detection units 24b, 26b, 28b are each provided for the detection of a foreign body in the charging region assigned to the respective detection unit 24b, 26b, 28b. Detection units 24b, 26b, 28b of handheld power tool charging device 10b are at least partly coordinated with one another.

Analogously to the preceding exemplary embodiment, handheld power tool charging device 10b is realized as an inductive charging device. Handheld power tool charging device 10b has a first transmit unit 30b that is provided to radiate energy for the energy transmission and that is made at least partly in one piece with first detection unit 24b. Handheld power tool charging device 10b has at least one additional transmit unit 32b, 34b that is provided to radiate energy for the energy transmission and that is made at least partly in one piece with the at least one additional detection unit 26b, 28b. In the present exemplary embodiment, handheld power tool charging device 10b has a plurality of transmit units 30b, 32b, 34b, each provided to radiate energy for the energy transmission and each made at least partly in one piece with a respective detection unit 24b, 26b, 28b. The charging regions are realized analogously to the preceding exemplary embodiment.

Analogously to the preceding exemplary embodiment, detection units 24b, 26b, 28b are at least partly temporally coordinated with one another. Detection units 24b, 26b, 28b are provided to detect, with a temporal offset, a foreign body in the charging regions respectively assigned to them. Detection units 24b, 26b, 28b are provided to detect, in succession, a foreign body in the charging regions respectively assigned to them. Relating to a detection process, handheld power tool charging device 10b has a sequence of detection units 24b, 26b, 28b. It is possible that the sequence can be determined by a user. It is possible that handheld power tool charging device 10b has an operating unit that is provided for a determination of the sequence by a user.

Analogously to the preceding exemplary embodiment, first detection unit 24b has at least one frequency channel having a frequency. Additional detection units 26b, 28b each have additional frequency channels that each have frequencies differing from the frequency channel of first detection unit 24b. In the present exemplary embodiment, detection units 24b, 26b, 28b have frequency channels having pairwise different frequencies. Analogously to the preceding exemplary embodiment, first detection unit 24b has a plurality of selectable frequency channels. The additional detection units 26b, 28b each have a plurality of selectable frequency channels. Detection units 24b, 26b, 28b are provided to automatically coordinate the frequency channels of detection units 24b, 26b, 28b among one another for a detection of a foreign body in the charging region assigned to the respective detection unit 24b, 26b, 28b.

First detection unit 24b and additional detection units 26b, 28b each have at least one interface 38b for a data transmission. Interface 36b of first detection unit 24b and interfaces 38b, 40b of additional detection units 26b, 28b are provided for an exchange of data of detection units 24b, 26b, 28b among one another. Interfaces 36b, 38b, 40b are provided for a coordination of detection units 24b, 26b, 28b among one another. In the present exemplary embodiment, interfaces 36b, 38b, 40b are provided to communicate and/or to receive signals for a dynamic coordination of the sequence of the detection processes of detection units 24b, 26b, 28b.

Differing from the preceding exemplary embodiment, first detection unit 24b and additional detection units 26b, 28b each have at least one interface 48b, 50b, 52b for a wireless data transmission. Interface 36b of first detection unit 24b is realized as an interface 48b for a wireless data transmission. Interfaces 38b, 40b of additional detection units 26b, 28b are each realized as an interface 50b, 52b for a wireless data transmission. Interface 48b of first detection unit 24b for a wireless data transmission and interfaces 50b, 52b of additional detection units 26b, 28b for a wireless data transmission are realized in the present exemplary embodiment as standardized interfaces 48b, 50b, 52b for a wireless data transmission.

Interface 48b of first detection unit 24b for a wireless data transmission and interfaces 50b, 52b of additional detection units 26b, 28b for a wireless data transmission are realized in the present exemplary embodiment as Wi-Fi interfaces. It is possible that interfaces 48b, 50b, 52b have some other standard that appears suitable to a person skilled in the art, and are realized for example as Bluetooth interfaces.

In a method for the wireless charging of the energy stores of handheld power tools using handheld power tool charging device 10b, first detection unit 24b of handheld power tool charging device 10b carries out, analogously to the preceding exemplary embodiment, a detection of a foreign body in the first charging region of handheld power tool charging device 10b, and additional detection units 26b, 28b of handheld power tool charging device 10b carry out a detection of a foreign body in additional charging regions of handheld power tool charging device 10b in a manner coordinated with one another. In the method, additional detection units 26b, 28b carry out the detection of a foreign body in the additional charging regions at least partly in temporal coordination with the detection of a foreign body by first detection unit 24b in the first charging region. In the present exemplary embodiment, first detection unit 24b and additional detection units 26b, 28b carry out the respective detection process in a manner dynamically coordinated with one another. For example, control and/or regulating units of detection units 24b, 26b, 28b ascertain a priority value that is respectively assigned to one of the detection units 24b, 26b, 28b, and, on the basis of the priority value, coordinate a sequence relating to the detection process. Detection units 24b, 26b, 28b coordinate the sequence with one another wirelessly, using a data transmission via interfaces 48b, 50b, 52b.

In the method, first detection unit 24b carries out the detection of a foreign body in the first charging region with a first frequency, and the additional detection units 26b, 28b carry out the detection of a foreign body in the additional charging regions with a frequency differing from the first frequency. Detection units 24b, 26b, 28b carry out the detection of a foreign body in the additional charging regions with a frequency differing from the first frequency and with a pairwise different frequency. First detection unit 24b and additional detection units 26b, 28b carry out the respective detection process in a manner dynamically coordinated with one another, relating to a frequency. Detection units 24b, 26b, 28b communicate the frequencies of detection units 24b, 26b, 28b wirelessly via interfaces 48b, 50b, 52b.

FIG. 4 shows another exemplary embodiment of a handheld power tool charging device 10c for energy stores of handheld power tools, provided for a wireless transmission of energy. Analogously to the preceding exemplary embodiment, handheld power tool charging device 10c has a first charging region and a first detection unit 24c for detecting a foreign body in the first charging region. Handheld power tool charging device 10c has at least one additional charging region and at least one additional detection unit 26c, 28c for detecting a foreign body in the additional charging region. Handheld power tool charging device 10c has a plurality of additional charging regions. A number of detection units 24c, 26c, 28c corresponds to a number of charging regions. A respective detection unit 24c, 26c, 28c is assigned to each charging region. Detection units 24c, 26c, 28c are each provided for the detection of a foreign body in the charging region assigned to the respective detection unit 24c, 26c, 28c. Differing from the preceding exemplary embodiments, first detection unit 24c is provided to begin the detection of a foreign body in the first charging region at an at least essentially random time. Additional detection units 26c, 28c are provided to begin the detection of a foreign body in the additional charging regions at at least essentially random times.

In the present exemplary embodiment, first detection unit 24c has a random number generator 66c that is provided to determine a pseudorandom number for a determination of a starting time of the detection process of first detection unit 24c. The additional detection units 26c, 28c each have a random number generator 68c, 70c. Random number generators 68c, 70c are each provided to provide a pseudorandom number for determining a start time of the respective detection process.

Analogously to the preceding exemplary embodiments, handheld power tool charging device 10c is realized as an inductive charging device. Handheld power tool charging device 10c has a first transmit unit 30c that is provided to radiate energy for the energy transmission and that is made at least partly in one piece with first detection unit 24c. Handheld power tool charging device 10c has at least one additional transmit unit 32c, 34c that is provided to radiate energy for the energy transmission and that is made at least partly in one piece with the at least one additional detection unit 26c, 28c. In the present exemplary embody, handheld power tool charging device 10c has a plurality of transmit units 30c, 32c, 34c, each provided to radiate energy for the energy transmission and each made at least partly in one piece with a respective one of the detection units 24c, 26c, 28c.

The charging regions of handheld power tool charging device 10c are fashioned analogously to the preceding exemplary embodiment. First detection unit 24c has at least one frequency channel having a frequency. It is possible that, analogous to the preceding exemplary embodiments, the additional detection units 26c, 28c each have additional frequency channels that each have frequencies differing from the frequency channel of first detection unit 24c. It is possible that first detection unit 24c has a plurality of selectable frequency channels, and that the additional detection units 26c, 28c each have a plurality of selectable frequency channels.

Differing from the preceding exemplary embodiments, first detection unit 24c and additional detection units 26c, 28c each do not have an interface for a data transmission. In the present exemplary embodiment, detection units 26c, 28c are realized so as to be independent of one another in terms of data.

In a method for the wireless charging of energy stores of handheld power tools by handheld power tool charging device 10c, first detection unit 24c of handheld power tool charging device 10c determine a start time for a detection process a detection of a foreign body in the first charging region of handheld power tool charging device 10c, and additional detection units 26c, 28c of handheld power tool charging device 10c a detection of a foreign body in additional charging regions of handheld power tool charging device 10c, in a manner pairwise independently of one another. First detection unit 24c and additional detection units 26c, 28c carry out the respective detection process at the respectively determined start time. First detection unit 24c and additional detection units 26c, 28c detect a foreign body in the charging region assigned to the respective detection unit 24c with a random temporal offset to one another and/or in succession.

1-13. (canceled)

14. A handheld power tool charging device for energy stores of handheld power tools, provided for wireless transmission of energy, the handheld power tool charging device comprising:
a first charging region;
a first detection unit for a detection of a foreign body in the first charging region;
at least one additional charging region; and
at least one additional detection unit for detection of a foreign body in the at least one additional charging region;
wherein the first detection unit and the at least one additional detection unit are at least partly coordinated with one another.

15. The handheld power tool charging device as recited in claim 14, further comprising:
a first transmit unit that radiates energy for the energy transmission and that is made at least partly in one piece with the first detection unit; and
at least one additional transmit unit to radiate energy for the energy transmission and is made at least partly in one piece with the at least one additional detection unit.

16. The handheld power tool charging device as recited in claim 14, wherein the first detection unit and the at least one additional detection unit are at least partly temporally coordinated with one another.

17. The handheld power tool charging device as recited in claim 14, wherein at least one of the first detection unit and the at least one additional detection unit, begins at least one of the detection of a foreign body in at least one of the first charging region, and the detection of a foreign body in the at least one additional charging region, at at least essentially random times.

18. The handheld power tool charging device as recited in claim 14, wherein the first detection unit has at least one frequency channel having a frequency, and the at least one additional detection has at least one additional frequency channel that has a frequency differing from the frequency channel of the first detection unit.

19. The handheld power tool charging device as recited in claim 14, wherein at least one of the first detection unit and the at least one additional detection unit has a plurality of selectable frequency channels.

20. The handheld power tool charging device as recited in claim 14, wherein the first detection unit and the at least one additional detection unit each has at least one interface for data transmission.

21. The handheld power tool charging device as recited in claim 14, wherein the first detection unit and the at least one additional detection unit each has at least one bus interface for data transmission.

22. The handheld power tool charging device as recited in claim 14, wherein the first detection unit and the at least one additional detection unit each has at least one interface for wireless data transmission.

23. A system, comprising:
a handheld power tool charging device for energy stores of handheld power tools, provided for wireless transmission of energy, the handheld power tool charging device including a first charging region, a first detection unit for a detection of a foreign body in the first charging region, at least one additional charging region, and at least one additional detection unit for detection of a foreign body in the at least one additional charging region, wherein the first detection unit and the at least one additional detection unit are at least partly coordinated with one another;
at least one energy store to be charged by the handheld power tool charging device, and, in at least one operating state, to supply energy to a handheld power tool.

24. A method for wireless charging of energy stores for handheld power tools using a handheld power tool charging device, the method comprising:
carrying out, by a first detection unit of the handheld power tool charging device, a detection of a foreign body in a first charging region of the handheld power tool charging device; and
carrying out, by at least one additional detection unit, a detection of a foreign body in at least one additional charging region of the handheld power tool charging device, in a manner coordinated with the first detection unit.

25. The method as recited in claim 24, wherein the at least one additional detection unit carries out the detection of a foreign body in the at least one additional charging region at least partly temporally coordinated with the detection of a foreign body by the first detection unit in the first charging region.

26. The method as recited in claim 24, wherein the first detection unit carries out the detection of a foreign body in the first charging region with a first frequency, and the at least one additional detection unit carries out the detection of a foreign body in the additional charging region with a frequency differing from the first frequency.
